(19) United States
(12) Patent Application Publication
(10) Pub. No.: US 2007/0206464 A1
(43) Pub. Date: Sep. 6, 2007

(54) APPARATUS AND METHOD FOR CHOOSING TARGET WRITE STRATEGY IN OPTICAL STORAGE SYSTEM

(76) Inventor: Jen-Hao Chang, Tai-Tung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,961

(22) Filed: Mar. 1, 2006

(51) Int. Cl. G11B 7/12

(52) U.S. Cl. 369/47.5; 369/53.31; 369/47.32

(57) ABSTRACT

An apparatus for selecting a target write strategy from a plurality of write strategies is disclosed. The apparatus includes a clock module, for monitoring time taken to write data to an optical disc and outputting a clock parameter; a first look-up table module comprising a plurality of write strategy control values corresponding to the write strategies respectively; a determination circuit, coupled to the first look-up table module and the clock module, for selectively outputting a target write strategy control value stored in the first look-up table module according to the clock parameter; and a write strategy circuit, coupled to the determination circuit, for generating the target write strategy based on the target write strategy control value outputted from the determination circuit.

### BACKGROUND OF THE INVENTION

1. Field of the Invention

The present invention relates to optical storage systems, and more particularly, to an apparatus and method for selecting a target write strategy from a plurality of write strategies.

2. Description of the Prior Art

Recent developments in optical disc technology have focused on re-recordable discs. Data can be written to a disc when it is rotating at a constant angular velocity (CAV) or a constant linear velocity (CLV). The data is written on a radial track, starting from the inside of the disc to the outside. For CLV data recording, since the linear velocity is constant, the recording speed is substantially constant. Therefore, if the disc characteristic variance is negligible, the write strategy applied for recording data onto an inner track can also be applied for recording data onto an outer track. In contrast to CLV data recording, however, CAV data recording requires adjusting the write strategy when writing data onto different tracks. The reason for this adjustment is that the linear velocity is not constant during the recording process, resulting in a variable recording speed. Generally, the recording speed at an inner track is slower than that at an outer track. In short, such an optical disc employs a plurality of write strategies, which modify the power of the laser beam, according to the linear velocity of the area on the disc to which data is being written. Different linear velocities will require different write strategies to modify the laser power according to the circumference of the track and/or the linear (tangential) velocity the disc is rotating at.

The optical storage industry has adopted a number of various algorithms for determining and switching among different write strategies. One example is illustrated in U.S. Pat. No. 6,535,470, the content of which is incorporated herein by reference, which discloses an optical disc drive using a velocity detector for detecting the linear velocity of the disc track currently being written to, and then selects and switches the write strategy to be applied according to the velocity detection result. The velocity detector works by comparing a range of nominal linear velocities with a detected velocity, and informing a controller once the detected velocity reaches a transition velocity, for example, 1.5 times the minimum velocity, or 1.5×, where X=minimum velocity. The velocity of the disc therefore needs to be continuously detected and compared with the range of nominal velocities, which are also updated once each transition velocity is reached. For example, once the transition velocity 1.5× is reached, the linear velocity of the disc will then be compared with another transition velocity 2×, until that transition velocity is reached. These determinations involve many calculations, which can affect the efficiency of recording data to the disc, and increase the complexity of the circuitry, thereby increasing the whole cost of the system.

### SUMMARY OF THE INVENTION

It is therefore an objective of the present invention to provide an apparatus and method for selecting a target write strategy for writing to an optical disc from among different write strategies according to a clock parameter.

According to the embodiments of the present invention, a write strategy determining method for use in an optical storage system is disclosed. The method comprises the steps of providing a count value according to time elapsed; providing a first switch time; comparing the count value and the first switch time; switching to a first write strategy according to the comparison result; and performing write operation of the optical storage system according to the first write strategy.

According to the embodiments of the present invention, an optical storage apparatus is also disclosed. The optical storage apparatus comprises a clock module for generating a count value according to time elapsed; a look-up table module including a plurality of switch time values; a storage module for storing a plurality of write strategy control values representative of a plurality of write strategies respectively; a controller coupled to the clock module and the look-up table module, for comparing the count value with a first switch time value from the switch time values in the look-up table module, and choosing a first write strategy control value from the write strategy control values according to the comparison result; and a write strategy circuit coupled to the storage module, for performing a write operation of the optical storage apparatus according to the chosen first write strategy control value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a write strategy system according to an embodiment of the present invention.

FIG. 2 is an exemplary diagram illustrating the content of the disc look-up table module in FIG. 1.

FIG. 3 is a flowchart of a write strategy selection process according to an embodiment of the present invention.

### DETAILED DESCRIPTION

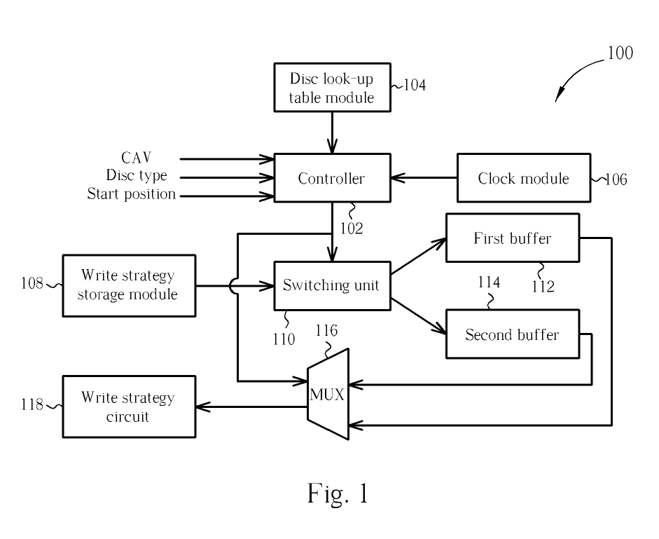

Please refer to FIG. 1. FIG. 1 is a diagram of a write strategy determining apparatus 100, being implemented in an optical storage device, such as a CD recorder or a DVD recorder, according to an embodiment of the present invention. The inventive write strategy determining apparatus 100 is generally realized in the form of one or more CD/DVD player/recorder controller chip(s). In FIG. 1, the write strategy determining apparatus 100 comprises: a controller 102, operating in conjunction with a disc look-up table module 104 and a clock module 106; a switching unit 110, which fetches data, according to the controller 102, from a write strategy storage module 108 and selectively stores the fetched data into a first buffer 112 and a second buffer 114; and a multiplexer (MUX) 116, which, also according to the controller 102, selectively passes data in the first buffer 112 or the second buffer 114 to subsequent circuitries, the subsequent circuitries hereinafter collectively termed as write strategy circuit 118, which may comprise known elements of an ordinary optical storage device that translate control values in the fetched data into waveforms representative of a corresponding write strategy, and perform write operations accordingly.

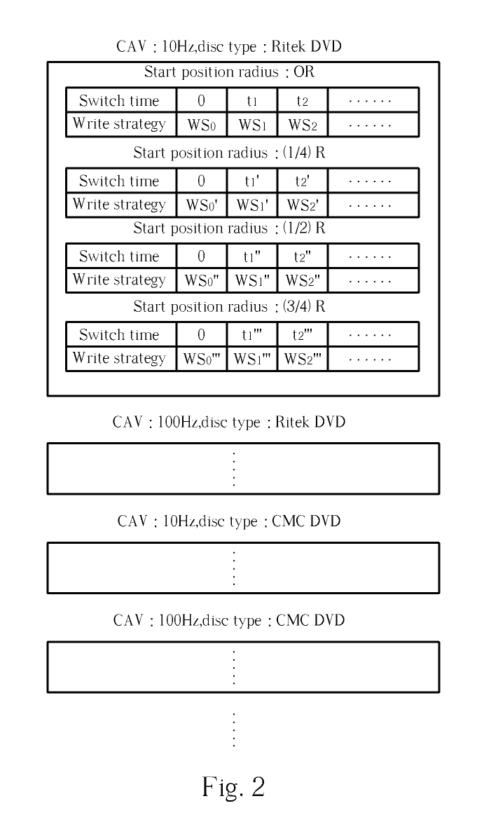

The disc look-up table module 104 is generally implemented with a programmable logic or memory unit which can be accessed according to disc information such as the constant angular velocity (CAV) to be applied, the particular disc type of the disc to be written to, and the detected start writing position of the disc to be written to, or other disc operation-related information. FIG. 2 shows an example of the content stored in the look-up table module 104. As shown in FIG. 2, in this embodiment a number of sets of switch time and their corresponding write strategy identity are stored in the look-up table module 104, the sets corresponding to each CAV value, each disc type, and each start writing position. As an example, assume a CAV to be used is set to 10 Hz, the disc to be written to is a DVD manufactured by Ritek, and the start writing position of the current disc is at or around the head of the disc, i.e. having a radius of or around 0. A series of sets of switch time and its corresponding write strategy identity (0, WS₀), (t₁, WS₁), (t₂, WS₂), . . . corresponding to these parameters are stored in the disc look-up table module 104. Similarly, utilizing the same conditions except for a start writing position being at or around a quarter radius of the disc, i.e. having a radius of or around (¼) R, where R is the radius of the disc, a series of sets of switch time and their corresponding write strategy identity (0, WS₀′), (t₁′, WS₁′), (t₂′, WS₂′), . . . are also stored. Consequently, similar sets of switch time and write strategy identity are respectively stored for various CAV, disc types, and start writing position combinations, as illustrated in FIG. 2.

It is to be noted that, although the switch times t₁, t₂, t₁′, t₂′, t₁″, t₂″, t₁′″, t₂′″ . . . are all differently and distinctly denoted, they may be assigned the same or different values in practice. It should also be noted that, although the write strategy identities WS₀, WS₁, WS₂, WS₀′, WS₁′, WS₂′, WS₀″, WS₁″, WS₂″, WS₀′″, WS₁′″, WS₂′″, . . . are all differently and distinctly denoted, in practice they may point to the same or different write strategy settings. It should further be noted that, although in FIG. 2 the choice of CAV is given as 10 Hz and 100 Hz, the choice of disc type is given as Ritek DVD and CMC DVD, and the choice of start writing position is given as at/around OR, (¼)R, (½)R, and (¾)R, these choices serve only as examples and are not meant to be limiting. Different choices of design are readily available for those of ordinary skill in the art.

The clock module 106 generates a count value referencing an internal clock or an external clock, the count value representative of time elapsed as measured by said internal/external clock, and the count value is compared with a switch time fetched by the controller 102 from the disc look-up table module 104, in order to determine when to switch from one write strategy to another write strategy. The write strategy storage module 52 stores a plurality of write strategy control values, each of which is identifiable by one of the above-mentioned write strategy identities. The write strategy control values contain information pertaining to write strategy parameters such as pickup laser power, etc., which are well known in the art, and later interpreted by the write strategy circuit 118 in order to control write operations. The switching unit 110, responsive to the controller 102, fetches write strategy control values stored in the write strategy storage module 108, and stores them in the first buffer 112 and the second buffer 114.

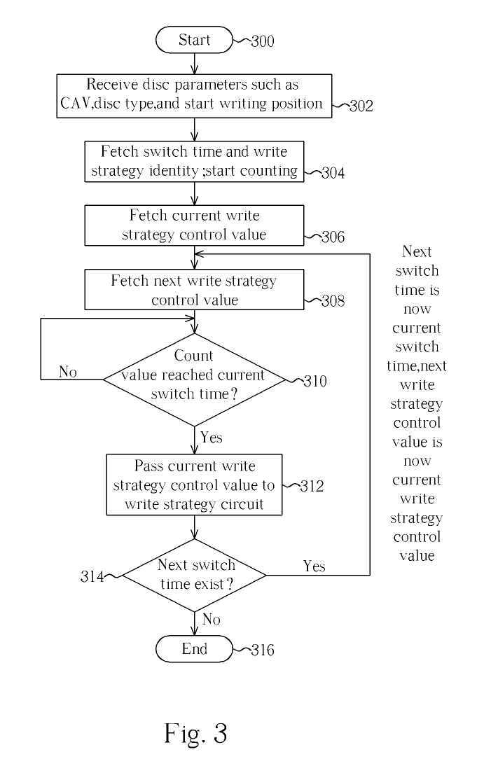

Please refer to FIG. 3. FIG. 3 is a flowchart of a write strategy selection process according to an embodiment of the present invention. The steps of the flowchart are detailed as follows.

Step 300: Start.

Step 302: Receive disc parameters such as CAV, disc type, and start writing position.

Step 304: Fetch switch time and write strategy identity, and start counting.

Step 306: Fetch current write strategy control value.

Step 308: Fetch next write strategy control value.

Step 310: Has count value reached the current switch time? If yes go to Step 312, if no go back to Step 310.

Step 312: Pass current write strategy control value to write strategy circuit.

Step 314: Does a next switch time exist? If yes go back to Step 308, if no go to Step 316.

Step 316: End.

When an optical disc (not shown) is being written to, the write strategy determining apparatus 100, implemented in an optical disc drive, receives the constant angular velocity, the disc type, and the start writing position detected and determined by the disc drive in a known way (step 302). Referencing the received CAV, disc type, start writing position, or any other possible combination of disc control parameters that may be used by those of ordinary skill in the art, the controller 102 fetches from the disc look-up table module 104 a corresponding set of switch time and write strategy identity according to the received disc parameters (step 304). For illustration, the set of switch time and write strategy identity corresponding to CAV=10 Hz, disc type=Ritek DVD, and start position radius=OR, i.e., (0, WS₀), (t₁, WS₁), (t₂, WS₂), . . . is used as an example. Accompanying the initiation of clock counting (step 304), the switching unit 110 is controlled by the controller to fetch a first write strategy control value according to the first write strategy identity WS₀ and stores the first write strategy control value in the first buffer 112 (step 306). The switching unit 110 is also controlled to fetch a second write strategy control value according to the second write strategy identity WS₁ and stores the second write strategy control value in the second buffer 114 (step 308).

The controller 102 then compares the first switch time with the count value (step 310). Since, in this embodiment, the first switch time is 0 and the clock module 106 starts counting from 0, a match is immediately found and the MUX 116 is consequently controlled by the controller to pass the first write strategy control value stored in the first buffer 112 to the write strategy circuit 118 (step 312). The write strategy circuit 118 then interprets the control value to form a corresponding write strategy for the write operation. Since there now exists a next switch time t₁, step 308 to step 312 will be repeated as follows (step 314).

Since the count value has exceeded the first switch time 0 and the first write strategy control value has been passed to the write strategy circuit 118, the switching unit 110 controlled by the controller 102 again fetches a next (i.e. a third) write strategy control value corresponding to a third write strategy identity WS₂ and stores the third write strategy control value in the first buffer 112, overwriting the first write strategy control value (step 308). The controller 102 compares the second switch time t1 with the count value (step 310) and controls the MUX 116 to pass the second write strategy control value stored in the second buffer 114 to the write strategy circuit 118 when a match is found (step 314). Steps 308 to 314 will be repeated until all the write strategies identified by the set are used or until the write operation ends.

Given a certain operating condition, e.g. where the CAV, disc type, and start writing position are known, the time the pickup will write data to a particular area of the disc and hence the desired write strategy are relatively predictable. Therefore, the content of the disc look-up table 104 and the write strategy storage module 108 can be designed accordingly. By implementing the proposed write strategy determining method, which determines the write strategy to be applied according to time elapsed, on-the-fly velocity detection is not required to determine the switching among various write strategies. As a result, the complex calculation accompanying velocity detection can be avoided, improving the efficiency of the circuit and reducing the overall cost of the system. It is to be noted that the order of the steps shown in FIG. 3 is merely exemplary and is not meant to be limiting. Other arrangements that conform to the spirit of the present invention still fall within the scope of the invention.

In another exemplary embodiment of the present invention, the present invention can be further altered by replacing the sets stored in the disc look-up table module 104 comprising switch time and write strategy identity with sets comprising switch time calculating constants and write strategy identities corresponding to each disc type. As an example, the look-up table module 104 stores a set of switch time calculating constants A, B, C, D, and E with respect to a Ritek type DVD. When the disc type is determined and the constants are fetched, the controller 102 calculates the switch times by applying the following functions:
t₁=A×CAV+B×position+C
t₂=D×t₁+E
t₃=D×t₂+E
tₙ₊₁=D×tₙ+E

The calculated switch times can then be used in a way similar to that taught in the previous embodiment. By doing so, the amount of information stored in the disc look-up table module 104 can be drastically reduced, and costs can thus be further lowered. It should be noted that the combination of the switch time calculating constants and the accompanying functions illustrated above serve merely as an example and are not meant to be limiting. Alteration of the amount and type of constants used and the complexity of the functions adopted still falls within the scope of the invention, as long as said alteration does not deviate from the spirit of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A write strategy determining method for use in an optical storage system, the method comprising:
providing a count value according to time elapsed;
providing a first switch time;
comparing the count value and the first switch time;
switching to a first write strategy according to the comparison result; and
performing write operation of the optical storage system according to the first write strategy.

2. The write strategy determining method of claim 1, further comprising:
generating the count value according to a clock signal.

3. The write strategy determining method of claim 1, further comprising:
providing a look-up table indexed by characteristics of a disc, the look-up table including a plurality of switch times, each switch time corresponding to a write strategy respectively.

4. The write strategy determining method of claim 3, wherein the characteristics of the disc comprise at least one constant angular velocity used in writing the disc, at least one disc type of the disc, and at least one start write position of the disc.

5. The write strategy determining method of claim 1, further comprising:
storing a plurality of write strategy control values representative of a plurality of write strategies respectively in a storage unit.

6. The write strategy determining method of claim 5, further comprising:
buffering a first write strategy control value representative of the first write strategy stored in the storage unit in a first buffer; and
buffering a second write strategy control value representative of a second write strategy stored in the storage unit in a second buffer.

7. The write strategy determining method of claim 6, further comprising:
choosing to utilize the first write strategy control value in the first buffer when the count value reaches the first switch time.

8. An optical storage apparatus, comprising:
a clock module for generating a count value according to time elapsed;
a look-up table module including a plurality of switch time values;
a storage module for storing a plurality of write strategy control values representative of a plurality of write strategies respectively;
a controller coupled to the clock module and the look-up table module, for comparing the count value with a first switch time value from the switch time values in the look-up table module, and choosing a first write strategy control value from the write strategy control values according to the comparison result; and
a write strategy circuit coupled to the storage module, for performing a write operation of the optical storage apparatus according to the chosen first write strategy control value.

9. The optical storage apparatus of claim 8, further comprising:
a memory access module coupled to the storage module, for fetching the write strategy control values stored in the storage module.

10. The optical storage apparatus of claim 9, further comprising:
a first buffer coupled to the memory access module, for buffering the first write strategy control value fetched by the memory access module; and
a second buffer coupled to the memory access module, for buffering a second write strategy control value fetched by the memory access module.

11. The optical storage apparatus of claim 10, further comprising:
a multiplexer coupled to the first buffer and the second buffer, for sending the first write strategy control value or the second write strategy control value to the write strategy circuit responsive to the controller.

12. The optical storage apparatus of claim 8, wherein the look-up table module is indexed by at least one constant angular velocity used in writing to a disc, at least one disc type of the disc, and at least one start write position of the disc.
